(19) United States
(12) Patent Application Publication
(10) Pub. No.: US 2004/0160927 A1
(43) Pub. Date: Aug. 19, 2004

(54) Method to measure performance and quality of wireless packet data services for end users

(76) Inventors: ZhongJin Yang, Naperville, IL (US); Jie Yao, Naperville, IL (US)

Correspondence Address: Werner Ulrich, 434 Maple Street, Glen Ellyn, IL, 60137, US

(21) Appl. No.: 10/369,165

(22) Filed: Feb. 19, 2003

(51) Int. Cl. H04Q 7/24

(52) U.S. Cl. 370/338; 370/349; 370/229; 370/517

(57) ABSTRACT

This invention relates to methods and apparatus for measuring the performance of packet transmission in a cellular wireless telecommunications network to a user of such a network. Test packetized data is transmitted to the user and echoed back by the user. Differences between the transmitted and received echoed packets and delay in receiving the packets are analyzed. Packets are echoed at the user's station without alerting the user. The test packets have time stamps in order to allow delay between the transmission of the test packet and the reception of the echoed test packet to be measured. The transmitted and echoed packets are analyzed to determine error rates and delay in order to determine a quality of service for the data transmission.

### TECHNICAL FIELD

This invention relates to the measurement of packet service performance for wireless users.

### BACKGROUND OF THE INVENTION

Cellular wireless telecommunications systems are being increasingly used for data purposes as well as voice. The provision of data, for example, to a traveling stock trader, is important to provide up to the minute data to an end user even when that end user is not in his/her home or office. Clearly, the provision of data to such users must be of high quality because it is frequently impossible for such users to use the normal human techniques for interpolating missing chunks of voice signals. Further, it is especially important to be able to establish whether reliable data transmission can be provided to a user at a particular location where that user may frequently stop and rely on the wireless data to keep the user informed.

A problem of the prior art is that there is no satisfactory method and apparatus for measuring the performance of cellular wireless data transmission.

### SUMMARY OF THE INVENTION

The above problem is solved and an advance is made over the teachings of the prior art in accordance with this invention wherein base stations and cellular stations are provided with facilities for echoing a received packet data stream and wherein a source of that data stream measures delay and error rates for the differences between the transmitted and the echoed packet data stream. In accordance with one preferred embodiment of the invention, the source of the packet data stream measures both the delay and error rate with respect to a packet data stream echoed by a base station (cellular site) and the delay and error rate for a packetized data stream echoed by the mobile station. This helps to differentiate between problems in the transmission of data to the base station and problems in the transmission of data from the base station to the mobile station. Further, by taking measurements of the same packet at the base station and the mobile station the delay from base station to mobile station can be measured separately from the delay from the switch to the mobile station.

### BRIEF DESCRIPTION OF THE DRAWING(S)

FIG. 1 is a block diagram illustrating the system for which quality of service is being measured;

FIG. 2 is a flow diagram illustrating the process of testing for quality of service between a source packet network and a base station; and

FIG. 3 is a flow diagram illustrating the process of measuring quality of service from the packet source to the mobile station user and the analysis of the two quality of service measures.

### DETAILED DESCRIPTION

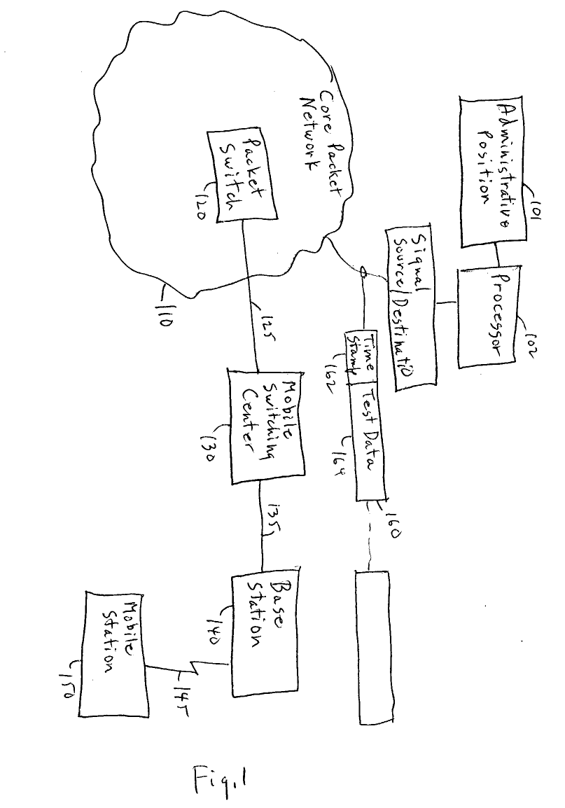

FIG. 1 is a system block diagram illustrating the operation of Applicants' invention. A mobile station 150 is connected via a radio link 145 to a base station 140. The base station is connected via a landline link 135 to a mobile switching center 130. The mobile switching center is connected to a core packet network 110 and specifically to a packet switch 120 at the edge of the core packet network via a data link 125.

A processor 102 controls a signal source/destination 105 for generating the test packetized data and for analyzing the return test packetized data. A packet 160 of the packetized test stream signal contains a time stamp 162 and test data 164. When the packetized test signal is sent from the source 105 to the base station 140 where it is echoed back to the signal source/destination 105 or is sent to mobile station 150 where it is echoed back to the signal source/destination 105. The time stamp of the originated data is compared with the time at which the returned data is received at the signal source/destination 105 to determine the delay associated with the transmission in the two directions. The differences between the source signal and the returned signal are analyzed by processor 102 which also analyzes the delay. Based on these analyses, a numerical quality of service for the two paths (i.e., to the base station and to the mobile station) is determined. Such a quality of service measurement can then be displayed or otherwise reported to a system administrator.

Processor 102 is controlled by a system administrator position 101 which accepts commands from a system administrator.

The base station and the mobile station must both be modified to respond to a test indicator in a received packet to simply echo the received test packet without further processing the packet or transmitting it onward. Each test packet has control data indicating that it is a test packet which is to be echoed and containing a destination address to which the packet is to be sent. If the control data indicates that this packet is to be echoed then the packet is not processed at the destination but is simply echoed and transmitted back to the source of the packet. The control data for a packet that is to be echoed by the mobile station must be different from the control data for echoing from the base station so that the base station knows that it should pass the test packet on.

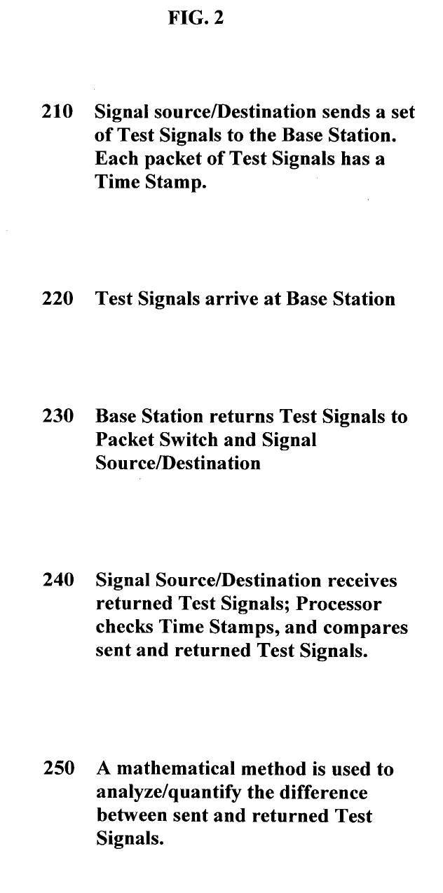

FIG. 2 is a flow diagram illustrating the process of testing the quality of service to the base station. The signal source/destination sends a set of testing signals to the base station 140. The test signals are provided by the processor. Each packet of test signals has a time stamp (action block 210). The test signals arrive at the base station (action block 220). The base station returns the test signals to the packet switch and the signal source/destination (action block 230). The signal source/destination receives the returned test signals, the processor checks the time stamps of the returned test signals and compares the sent and returned signals (action block 240). A mathematical method is used to analyze/quantify the difference between sent and returned test signals (action block 250).

The transmitted signal and returned signal are compared quantitatively to determine the delay, the loss rate of the packets, and the error rate. These can be analyzed as a function of the packet size, the priority of the packet, and the packet pattern. The analysis can show both a mean and a standard deviation of the parameters being measured. The quality of service can be defined in terms of objective values of these means and standard deviations.

In order to realize Applicants' invention, it is necessary that the mobile station be enhanced to include a mode of operation wherein if a packet is marked as a test packet it is echoed to the source of that test packet. It is also desirable to introduce a similar facility in the base station so that landline problems such as excessive delay for non-priority packets can be distinguished from problems of communicating with the mobile station.

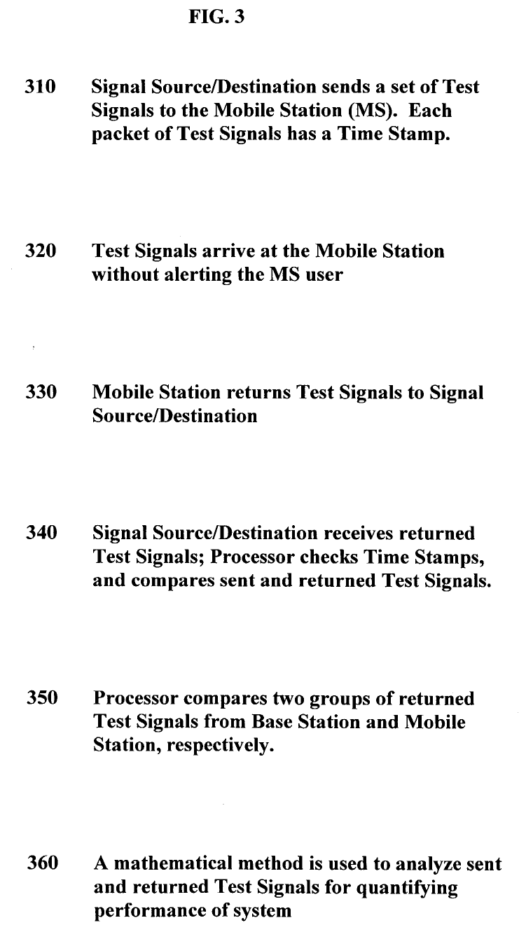

FIG. 3 is a flow diagram illustrating the process of testing the path to a mobile station and analyzing the results to determine the quality of service to the mobile station as contrasted to the quality of service to the base station. The signal source/destination sends a set of test packets to the mobile station. Each test packet has a time stamp, as well as indicators that this is a test packet and the destination of the test packet (action block 310). The test packets arrive at the mobile station without alerting the mobile station user (action block 320). The signal source/destination receives the returned test packets. The processor then checks the time stamps and compares the sent and returned test packets (action block 340). The processor compares the two groups of returned test packets from the base station and mobile station respectively (action block 350). Finally, a mathematical method is used to analyze the sent and returned test signals for quantifying performance of the system (action block 360).

The above description is of one preferred embodiment of Applicants' invention. Other embodiments will be apparent to those of ordinary skill in the art without departing from the scope of the invention. The invention is limited only by the attached claims.

1. In a cellular wireless data packet telecommunications system, a method for measuring quality of service for data transmission to a mobile station comprising the steps of:
transmitting data packets from a source to said mobile station;
echoing the transmitted data packets to the source; and
analyzing delays and differences between the data packets transmitted from said source and the data packets returned to said source/destination.

2. The method of claim 1 wherein the step of transmitting data packets comprises the step of including a time stamp in the data packets transmitted from said source.

3. The method of claim 2 wherein the step of analyzing delays and differences comprises the step of determining the delay by comparing a source of present time with time stamps transmitted with said data packets.

4. The method of claim 1 further comprising the steps of:
transmitting data packets from a source to a base station serving said mobile station;
echoing the transmitted data packets from said base station to said source; and
analyzing delays and differences between the data packets transmitted from said source to said base station and the data packets returned by said base station to said source/destination.

5. The method of claim 1 wherein the step of echoing comprises the step of echoing without alerting the mobile station user.

6. The method of claim 1 wherein the step of transmitting data packets comprises the step of transmitting data packets at different priority levels; and
wherein the step of analyzing delays and differences comprises the step of analyzing delay as a function of the priority of transmitted data packets.

7. The method of claim 1 wherein the step of analyzing delays and differences comprises the step of determining whether there are out of sequence packets, determining an error rate for bits and for data packets, and determining a loss rate for data packets.

8. In a cellular wireless data packet telecommunications system, apparatus for measuring quality of service for data transmission to a mobile station, comprising:
means for transmitting data packets from a source to said mobile station;
means for echoing the transmitted data packets to the source; and
means for analyzing delays and differences between the data packets transmitted from said source and the data packets returned to said source/destination.

9. The apparatus of claim 8 wherein the means for transmitting data packets comprises means for including a time stamp in the data packets transmitted from said source.

10. The apparatus of claim 9 wherein the means for analyzing delays and differences comprises means for determining the delay by comparing a source of present time with time stamps transmitted with said data packets.

11. The apparatus of claim 8 further comprising:
means for transmitting data packets from a source to a base station serving said mobile station;
means for echoing the transmitted data packets from said base station to said source; and
means for analyzing delays and differences between the data packets transmitted from said source to said base station and the data packets returned by said base station to said source/destination.

12. The apparatus of claim 8 wherein the means for echoing comprises means for echoing without alerting the mobile station user.

13. The apparatus of claim 8 wherein the means for transmitting data packets comprises the step of transmitting data packets at different priority levels; and
wherein the step of analyzing delays and differences comprises the step of analyzing delay as a function of the priority of transmitted data packets.

14. The apparatus of claim 8 wherein the step of analyzing delays and differences comprises the step of determining whether there are out of sequence data packets, determining an error rate for bits and for data packets, and determining a loss rate for data packets.
